(19) United States
(12) Patent Application Publication
(10) Pub. No.: US 2011/0149845 A1
(43) Pub. Date: Jun. 23, 2011

(54) METHOD AND SYSTEM FOR PERFORMING ONE-TO-ONE AND GROUP COMMUNICATION CONCURRENTLY IN A WIRELESS IP NETWORK

(75) Inventors: Moon Sub SONG, Daejeon (KR); Moon Kyun Oh, Daejeon (KR); Ho Sang Ham, Daejeon (KR)

(73) Assignee: Electronics and Telecommunications Research Institute, Daejeon (KR)

(21) Appl. No.: 12/785,672

(22) Filed: May 24, 2010

(30) Foreign Application Priority Data
Dec. 18, 2009 (KR) 10-2009-0127350

(51) Int. Cl. H04W 88/00

(52) U.S. Cl. 370/328; 370/352

(57) ABSTRACT

A system and method for concurrently performing a group communication and a one-to-one communication in a wireless Internet Protocol (IP) network are disclosed. The method includes requesting, upon receipt of a one-to-one communication request from another terminal during a voice group communication, a concurrent mode service to the server by a compound terminal, determining, upon receipt of a group communication IP packet, whether there is a concurrent mode user among group members to receive a voice data packet corresponding to the group communication IP packet by a server, converting the group communication IP packet to a text data packet in the presence of a concurrent mode user by the server, transmitting the text data packet to the concurrent mode user by the server, and transmitting the voice data packet corresponding to the group communication IP packet to group communication mode users except for the concurrent mode user by the server.

### CROSS-REFERENCE TO RELATED APPLICATIONS

This application claims priority under 35 U.S.C. §119 to Korean Patent Application No. 10-2009-127350, filed on Dec. 18, 2009, in the Korean Intellectual Property Office, the disclosure of which is incorporated herein by reference in its entirety.

### TECHNICAL FIELD

The following disclosure relates to a method and system for performing one-to-one communication and group communication concurrently, and in particular, to a method and system for performing one-to-one communication and group communication concurrently in a wireless Internet Protocol (IP) network.

### BACKGROUND

Conventionally, a Trunked Radio System (TRS) terminal is capable of making a group conversation and a one-to-one conversation. TRS is a frequency-sharing communication system being a kind of mobile communication system, which offers both a radio function and a portable phone function. Commercial TRS services have been deployed.

A shortcoming with IRS is that a group conversation is established using a limited frequency and thus there is a limit on the number of available groups. Another shortcoming with TRS is that a group conversation and a one-to-one conversation may not be conducted at the same time because TRS supports only voice communication.

### SUMMARY

Therefore, the present invention has been made in view of the above problems, and it is an object of the present invention to provide a method and system for performing a group communication and a one-to-one communication concurrently without interrupting the group communication, upon receipt of an one-to-one communication request during the group communication (voice communication) of a user in progress.

To achieve the above and other objects, the present invention provides a system for performing a group communication and a one-to-one communication, including a compound terminal for supporting a group communication and a one-to-one communication, and a server connected to the compound terminal over a wireless Internet Protocol (IP) network, for supporting a group communication and a one-to-one communication. The compound terminal includes a transmitter having a microphone for receiving voice from a user and processing the voice, a microphone controller for controlling the microphone, a voice data generator for converting analog voice information to digital voice data, and an IP packet transmitter for converting the digital voice data to an IP packet, a receiver having an IP packet receiver for receiving an IP packet from the server, a voice data processor for, if the received IP packet carries voice data, processing the voice data to analog voice information, a speaker for reproducing the analog voice information to voice, a speaker controller for controlling the speaker, a text data processor for, if the received IP packet carries text data, converting the text data to a text message suitable for the compound terminal, a display for displaying the text message to a user, and a display controller for controlling the display, and a Push-To-Talk (PTT) button. The server includes an IP packet receiver for receiving an IP packet from the compound terminal, an IP packet processor for processing the received IP packet according to states of group members, a voice recognizer for recognizing voice data and generating text data from the recognized voice data, in the presence of a group member to receive the received IP packet as text data, and an IP packet transmitter for transmitting an IP packet to the compound terminal.

The compound terminal may support a group communication mode, a concurrent mode, and a one-to-one communication mode. The server may further include a group/user management database for storing information on the states of group members.

In accordance with the present invention, the above and other objects can be accomplished by the provision of a method for concurrently performing a group communication and a one-to-one communication between a compound terminal and a server that are connected to each other over a wireless IP network and support a group communication and a one-to-one communication, including requesting, upon receipt of a one-to-one communication request from another terminal during a voice group communication, a concurrent mode service to the server by the compound terminal, determining, upon receipt of a group communication IP packet, whether there is a concurrent mode user among group members to receive a voice data packet corresponding to the group communication IP packet by the server, converting the group communication IP packet to a text data packet in the presence of a concurrent mode user by the server, transmitting the text data packet to the concurrent mode user by the server, and transmitting the voice data packet corresponding to the group communication IP packet to group communication mode users except for the concurrent mode user by the server.

The method may further include storing information on a state of the compound terminal in a group/user management database by the server, after the concurrent mode service is requested, and it may be determined whether there is a concurrent mode user, referring to the group/user management database.

Other features and aspects will be apparent from the following detailed description, the drawings, and the claims.

### BRIEF DESCRIPTION OF THE DRAWINGS

FIG. 1 illustrates an overall configuration of a system for performing a group communication and a one-to-one communication according to an exemplary embodiment of the present invention.

FIG. 2 is a flowchart illustrating an operation for processing a one-to-one communication request, upon receipt of the one-to-one communication request during a group communication of a user in a method for performing a group communication and a one-to-one communication concurrently according to an exemplary embodiment of the present invention.

FIG. 3 is a state diagram illustrating three states available to a compound terminal for performing a group communication and a one-to-one communication concurrently according to an exemplary embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

In accordance with the exemplary embodiments of the present invention, upon receipt of a one-to-one communication request during a group communication in progress, a group communication message is displayed in text, so that the one-to-one communication may be made concurrently with the group communication.

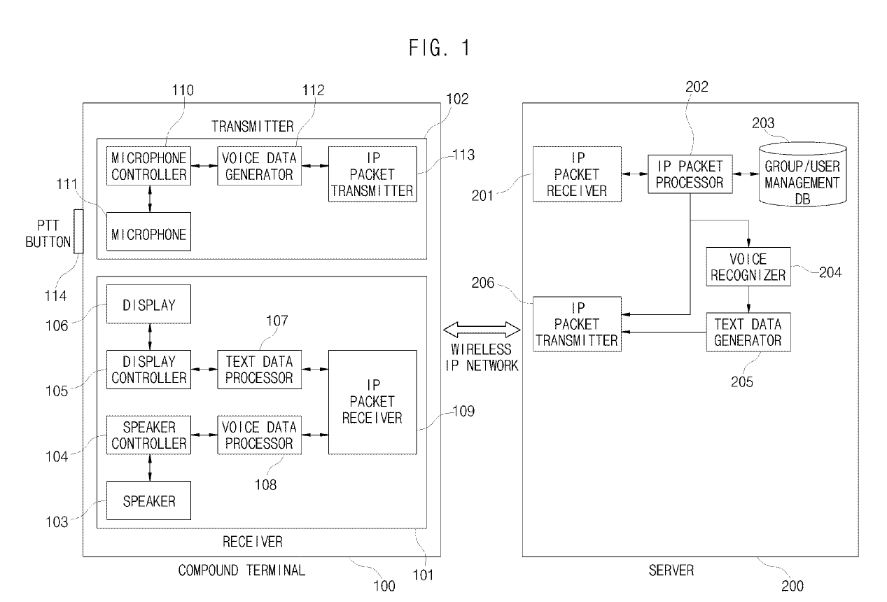

FIG. 1 illustrates an overall configuration of a system for performing a group communication and a one-to-one communication according to an exemplary embodiment of the present invention.

Referring to FIG. 1, a system for performing a group communication and a one-to-one communication includes a compound terminal 100 and a server 200, which support a group communication and a one-to-one communication. The compound terminal 100 is connected to the server 200 over a wireless Internet Protocol (IP) network.

The compound terminal 100 includes a transmitter 102, a receiver 101, and a Push-To-Talk (PTT) button 114.

The transmitter 102 has a microphone 111 for receiving voice from a user and processing the voice, a microphone controller 110 for controlling the operation of the microphone 111, a voice data generator 112 for converting analog voice information to digital voice data, and an IP packet transmitter 113 for converting the digital voice data to an IP packet and transmitting the IP packet. The receiver 101 has an IP packet receiver 109 for receiving an IP packet from the server 200, a voice data processor 108 for, if the received IP packet carries voice data, converting the voice data to analog voice information, a speaker 103 for reproducing the processed analog voice information to voice, a speaker controller 104 for controlling the speaker 103, a text data processor 107 for, if the received IP packet carries text data, converting the text data to a text message suitable for the compound terminal 100, a display 106 for displaying the text message to the user, and a display controller 105 for controlling the display 106.

Since the compound terminal 100 is a mobile communication terminal, it apparently includes basic components of a mobile communication terminal, such as a call button, an end button, an OK button, etc.

The server 200 includes an IP packet receiver 201 for receiving an IP packet from the compound terminal 100, an IP packet processor 202 for processing the received IP packet according to the states of group members, a group/user management database (DB) 203 for storing information about the states of group members, a voice recognizer 204 for recognizing voice data in the presence of a group member to receive the received IP packet as text data, a text data generator 205 for generating text data using the recognized voice data, and an IP packet transmitter 206 for transmitting an IP packet to the compound terminal 100.

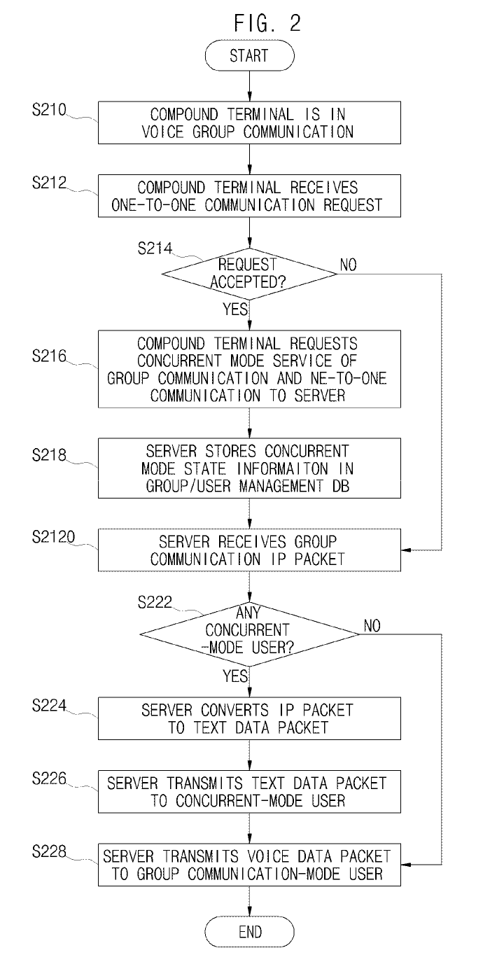

Now a description will be made of a method for conducting a communication in the above system for performing a group communication and a one-to-one communication. FIG. 2 is a flowchart illustrating an operation for processing a one-to-one communication request, upon receipt of the one-to-one communication request during a group communication of a user according to an exemplary embodiment of the present invention.

Referring to FIG. 2, group members are talking in a voice group communication in step S210. Upon receipt of a one-to-one communication request from another terminal during the voice group communication in step S212, a user accepts or rejects the one-to-one communication request in step S214.

When the user accepts the one-to-one communication request, the compound terminal 100 notifies the server 200 of its state and requests a concurrent mode service to the server 200 in step S216. Then the server 200 stores information about the state of the compound terminal 100 in the group/user management DB 230 in step S218.

Upon receipt of a group communication IP packet later in step S220, the server 200 determines whether there is any concurrent mode user among group members that will receive a voice packet corresponding to the group communication IP packet, referring to the group/user management DB 230 in step S222.

In the presence of a concurrent mode user (i.e. the compound terminal 100), the server 200 converts the received IP packet to a text data packet in step S224 and transmits the text data packet to the concurrent mode user in step S226. In step S228, the server 200 transmits the voice packet to group communication mode users.

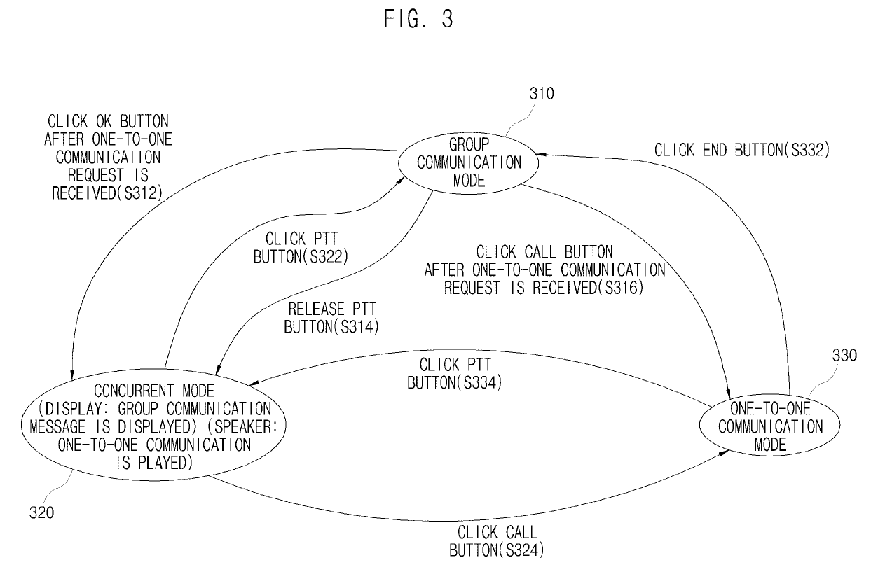

FIG. 3 is a state diagram illustrating three states available on the compound terminal 100 according to an exemplary embodiment of the present invention.

Referring to FIG. 3, the user may communicate in various manners by transitioning to a group communication mode 310, a concurrent mode 320, and a one-to-one communication mode 330 using the call button, the end button, the OK button, and the PTT button of the compound terminal 100.

Upon receipt of a one-to-one communication request in the group communication mode 310, the user may transit to the concurrent mode 320 by clicking the OK button in step S312. In the concurrent mode 320, the user may conduct a one-to-one communication through the speaker and the microphone, while group communication messages are displayed on the display of the compound terminal 100, as described before with reference to FIG. 2.

If the user intends to speak in the group communication in the concurrent mode 320, he/she may talk by clicking the PTT button in step S322. Then the one-to-one communication function is temporarily interrupted and the voice uttered through the microphone is transmitted to the group members of the group communication. If the user finishes talking and releases the PTT button in step S314, the user returns to the concurrent mode 320.

If the user clicks the call button instead of the OK button when receiving the one-to-one communication request, he/she transits to the one-to-one communication mode 330 in step S316. Then the group communication function is deactivated. However, if the group communication is still going on after the one-to-one communication ends, the user may transit to the group communication mode 310 by clicking the end button in step S332.

If the user wants to transit from the one-to-one communication mode 330 to the concurrent mode 320, he/she clicks the PTT button in step S334. On the other hand, the user transits from the concurrent mode 320 to the one-to-one communication mode 330 by clicking the call button in step S324.

While it has been described in the exemplary embodiment of the present invention that mode transitions take place by manipulating the OK, call, end and PTT buttons by way of example, the mode transition method is not limited to the use of the buttons. For mode transitions, a separately secured button may be used or other existing buttons may be used.

As is apparent from the above description, a user is allowed to perform a data communication during a voice communication, according to user selection. Therefore, a group communication and a one-to-one communication can be performed concurrently.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for performing a group communication and a one-to-one communication, the system comprising:
a compound terminal for supporting a group communication and a one-to-one communication; and
a server connected to the compound terminal over a wireless Internet Protocol (IP) network, for supporting a group communication and a one-to-one communication,
wherein the compound terminal includes:
a transmitter having a microphone for receiving voice from a user and processing the voice, a microphone controller for controlling the microphone, a voice data generator for converting analog voice information to digital voice data, and an IP packet transmitter for converting the digital voice data to an IP packet;
a receiver having an IP packet receiver for receiving an IP packet from the server, a voice data processor for, if the received IP packet carries voice data, processing the voice data to analog voice information, a speaker for reproducing the analog voice information to voice, a speaker controller for controlling the speaker, a text data processor for, if the received IP packet carries text data, converting the text data to a text message suitable for the compound terminal, a display for displaying the text message to a user, and a display controller for controlling the display; and
a Push-To-Talk (PTT) button, and
wherein the server includes:
an IP packet receiver for receiving an IP packet from the compound terminal;
an IP packet processor for processing the received IP packet according to states of group members;
a voice recognizer for recognizing voice data and generating text data from the recognized voice data, in the presence of a group member to receive the received IP packet as text data; and
an IP packet transmitter for transmitting an IP packet to the compound terminal.

2. The system according to claim 1, wherein the compound terminal supports a group communication mode, a concurrent mode, and a one-to-one communication mode.

3. The system according to claim 1, wherein the server further includes a group/user management database for storing information on the states of group members.

4. A compound terminal of a system for performing a group communication and a one-to-one communication, having the compound terminal and a server which are connected to each other over a wireless Internet Protocol (IP) network and support a group communication and a one-to-one communication, the compound terminal comprising:
a transmitter having a microphone for receiving voice from a user and processing the voice, a microphone controller for controlling the microphone, a voice data generator for converting analog voice information to digital voice data, and an IP packet transmitter for converting the digital voice data to an IP packet;
a receiver having an IP packet receiver for receiving an IP packet from the server, a voice data processor for, if the received IP packet carries voice data, processing the voice data to analog voice information, a speaker for reproducing the analog voice information to voice, a speaker controller for controlling the speaker, a text data processor for, if the received IP packet carries text data, converting the text data to a text message suitable for the compound terminal, a display for displaying the text message to a user, and a display controller for controlling the display; and
a Push-To-Talk (PTT) button.

5. The compound terminal according to claim 4, wherein a group communication mode, a concurrent mode, and a one-to-one communication mode are supported.

6. A server of a system, for performing a group communication and a one-to-one communication, having a compound terminal and the server which are connected to each other over a wireless Internet Protocol (IP) network and support a group communication and a one-to-one communication, the server comprising:
an IP packet receiver for receiving an IP packet from the compound terminal;
an IP packet processor for processing the received IP packet according to states of group members;
a voice recognizer for recognizing voice data and generating text data from the recognized voice data, in the presence of a group member to receive the received IP packet as text data; and
an IP packet transmitter for transmitting an IP packet to the compound terminal.

7. The server according to claim 6, further comprising a group/user management database for storing information about the states of group members.

8. A method for concurrently performing a group communication and a one-to-one communication between a compound terminal and a server that are connected to each other over a wireless Internet Protocol (IP) network and support a group communication and a one-to-one communication, the method comprising:
requesting, upon receipt of a one-to-one communication request from another terminal during a voice group communication, a concurrent mode service to the server by the compound terminal;
determining, upon receipt of a group communication IP packet, whether there is a concurrent mode user among group members to receive a voice data packet corresponding to the group communication IP packet by the server;
converting the group communication IP packet to a text data packet in the presence of a concurrent mode user by the server;
transmitting the text data packet to the concurrent mode user by the server; and
transmitting the voice data packet corresponding to the group communication IP packet to group communication mode users except for the concurrent mode user by the server.

9. The method according to claim 8, further comprising storing information on a state of the compound terminal in a group/user management database by the server, after the concurrent mode service is requested, wherein the determination comprises determining whether there is a concurrent mode user, referring to the group/user management database.

10. The method according to claim 8, further comprising:
requesting termination of the concurrent mode service to the server by the compound terminal; and
transmitting a voice data packet corresponding to group communication IP packet to group communication mode users including the compound terminal, upon receipt of the group communication IP packet after receiving the request for termination of the concurrent mode service from the compound terminal.
